(19) United States
(12) Patent Application Publication
(10) Pub. No.: US 2011/0291332 A1
(43) Pub. Date: Dec. 1, 2011

(54) Method and device for the temperature control of preforms

(75) Inventors: Klaus Voth, Obertraubling (DE); Frank Winzinger, Regensburg (DE); Konrad Senn, Regensburg (DE)

(73) Assignee: KRONES AG, Neutraubling (DE)

(21) Appl. No.: 13/068,603

(22) Filed: May 16, 2011

(30) Foreign Application Priority Data
May 25, 2010 (DE) 10 2010 021 446.9

(51) Int. Cl. B29C 49/64; B29C 49/68; B65B 3/02; B29C 49/28

(52) U.S. Cl. 264/532; 264/523; 264/345; 425/526; 53/452

(57) ABSTRACT

A method for the at least two-stage temperature control of preforms (28) made from a thermoplastic material. In this method, the preforms (28) are brought, immediately prior to a blow molding or a stretch blow molding process, to a process-specifically distributed softening temperature (T3) according to a predefineable thermal profile, with said softening temperature (T3) being the temperature required for blow molding or stretch blow molding at least the preform's (28) body section located below the thread section (29) and/or a collar area located therebelow. In addition, the preforms (28) are first preheated to a near uniform temperature, particularly with a largely homogeneous temperature distribution (T2).

The invention furthermore includes a heating device (10) for performing the method.

This claims the benefit of German Patent Application DE 10 2010 021 446, filed May 25, 2010 and hereby incorporated by reference herein.

The present invention relates to a method for controlling the temperature of performs. The invention furthermore relates to a heating device for controlling the temperature of performs.

### BACKGROUND

Beverage containers made from thermoplastic materials, especially from the most widely used PET, are commonly produced in a stretch blow molding process. In this mostly two-stage stretch blow molding process the containers are typically produced from injection-molded, rotationally symmetric preforms. Said preforms consist of an elongated, cylindrical, lateral body section with a rounded, closed bottom and a neck section with an upper opening, which can also be referred to as mouthpiece section. Positioned close to this opening there is usually a thread section, which can be delimited toward the bottom by a collar or the like. Already during the injection-molding process of the preform is the said thread section produced to the final dimensions that will be required for later use. During the stretch blow molding process it continues to keep its original shape and later forms the thread for the screw cap of the finished beverage container. The remaining sections of the preform are, in contrast, deformed and stretched. During the manufacturing process the preforms are heated to a predefined magnitude of process temperature in order to enable forming by stretch blow molding in the desired manner, with uniform wall thickness and without causing the material to tear. The heating is mostly effected by means of infrared radiation, because in this manner it is possible to ensure defined and uniform temperature control of the preforms.

The plastic material intended for further processing (in general PET) is of such a nature that it will strain harden as it is stretched. Of decisive importance in this process is the forming temperature. The strain hardening effect is normally put to use in the production of PET containers for the purpose of controlling and optimizing wall thickness distribution. Temperature profiling has proved to be an advantageous method for heating the preforms as uniformly as possible, on the one hand, thereby however avoiding, on the other hand, mechanical damage to the neck section and the container thread, which would result from too much heat prior to the stretch blow molding process.

Depending on the production process, it is possible to apply the infrared radiation in such a way that the preforms are heated according to a desired temperature profile. The aim of this is to have the warmer sections deformed with priority to the other parts as long as is required for the stretching resistance resulting from strain hardening to become greater than the resistance of the adjacent cooler sections. Commonly, the temperature profile is uniformly distributed around the circumference of the preforms and can vary process-dependently along the longitudinal axis of said preforms.

A system and a method for pretreating preforms, whereby the said preforms are heated prior to a blow molding process, is known from EP 0 736 367 B1. The preforms are thereby uniformly pretreated with regard to their temperature before they are heated again for the following blow molding. The pretreatment should be defined by the thermal energy contained in each preform, whereby the temperature differences between the preforms are supposed to be reduced or kept at a low level.

DE 25 45 134 A1 describes a method for heating preforms made from a thermoplastic material to blowing temperature by means of infrared radiation. In this method, the preforms are heated until they have uniformly reached a first temperature level that is below blowing temperature. Starting from this first temperature level, the preforms are subsequently further heated by means of infrared radiation until they have reached the required final temperature.

The invention aims primarily at providing an improved and particularly energy-efficient method for the temperature control of preforms in connection with a stretch blow molding process, whereby the said preforms are heated according to a desired temperature profile with said temperature profile being largely predefineable, in any occurring external conditions, to an exact degree. It is intended that the thermal energy required for the temperature control can be made available as efficiently and at as low a cost as possible. A further aim of the invention is to provide an improved heating device for preforms, by means of which the temperatures and temperature profiles required for the preforms can be set and predefined as exactly and with as reduced an energy input as possible.

### SUMMARY OF THE INVENTION

It is an object of the present invention to provide an at least two-stage method for the temperature control of preforms made from a thermoplastic material, especially from PET, whereby the preforms are brought to a softening temperature required for blow molding or stretch blow molding the plastic material, this heating taking place either during or prior to the said process of blow molding or stretch blow molding, whereby the thermal profile can be predefined and the said softening temperature is accordingly process-specifically distributed. In the current context, “process-specifically distributed” or “process-specifically distributed temperature” is intended to mean that a temperature profile, applied longitudinally along the preform, is adjusted in such a manner as to correspond to how the material of the preform is to be distributed during the process of blow molding in the specific instance and under the specific process-technical conditions.

The temperature control process comprises at least two different, consecutive heating stages, each with different tasks to fulfill. The first heating stage is intended for achieving an approximately uniform base temperature of the entire preform, with said base temperature corresponding at the most to the maximum heating temperature for maintaining the dimensional stability of the thread section at the preform's open-topped neck section. The second heating stage is intended for achieving a process-specifically distributed softening temperature according to a predefineable thermal profile, with said softening temperature being the temperature required for blow molding or stretch blow molding at least the preform's body section located below the thread section and/or a collar area located therebelow. The present invention provides an improved concept for thermal layering for the preforms. The heating is achieved in two stages, on the one hand in order to optimally prepare and temperature-control the preform for the stretch blow molding process so that the containers shaped in the process will have as uniform a wall thickness as possible and so that scrap resulting from defective containers is reduced to a minimum. On the other hand, the two-stage temperature control process is intended to be achieved at a reduced energy input, which is already to be ensured by the two-stage heating with the initially uniform preheating and the subsequent specific temperature profiling.

According to the invention, the heating is achieved in at least two consecutive sections or heating stages of the heating device. The first section provides the preforms with basic heating in order to heat them to a base temperature that is as uniform as possible and that is below the softening temperature of the plastic material. This temperature limit is necessary in order to avoid, as far as possible, that the thread section is unduly heated. Thermal layering is not yet applied during this basic heating phase, as the intention is to achieve a uniform temperature distribution over the entire body of the preform. The defined base temperature should typically range between at least 50° C. and up to 90° C., thus allowing to compensate for different input and storage conditions of the preforms. As the preforms are likely to have been stored in different locations at different temperatures before being supplied to the stretch blow molding process, it is necessary to provide uniform input conditions for the preforms in order to achieve the best forming results possible. Accordingly, a basic heating phase constitutes the first temperature control stage and a subsequent temperature profiling phase constitutes the second temperature control stage.

During the temperature profiling phase that constitutes the second heating stage, the preforms are heated with the temperatures being layered in direction of the longitudinal axis of the said preforms. As the case may be, it is possible to allow for a temperature measurement prior to temperature profiling in order to record the temperature of the preforms after the basic heating and to accordingly adjust the heating stages. It is optionally possible to allow for a further temperature measurement after the second heating stage in order to record the preforms' final temperature after the second heating stage or after the temperature profiling phase and to accordingly take the recorded temperatures into account when adjusting the first heating stage.

It is advantageous for the preforms to be heated to a largely uniform base temperature ranging between approximately 50° C. and approximately 90° C. in the section of the first heating stage or the basic heating phase. This temperature depends primarily on the maximum allowable temperature for the neck section of the preforms made from PET or another suited thermoplastic material, because this section with its thread that is to be used later is not to be changed and deformed during heating and the subsequent stretch blow molding process, but rather to remain unaltered and maintain its size and shape during all processing stages. An advantageous variant of the method according to the invention allows for the preforms to be heated to the base temperature in the section of the first heating stage by inserting heating elements into the open-topped preforms. The heating elements function as so-called boosters in that they require a very short time for bringing the respective preform from storage temperature to the desired base temperature, which is brought to a yet higher temperature level in the subsequent heating stage by applying a temperature profile. This booster or heating element may be of a typical length that corresponds to an individual radiant heater, thus enabling a largely homogeneous heating of the preforms. Moreover, it is also possible for further radiators to function as components of the said booster, with said components applying heat radiation to the outside of the preforms for achieving the desired basic heating.

Furthermore, an especially advantageous embodiment variant of the method according to the invention may be performed by applying hot air to the preforms to preheat them before they are conveyed into a heating device and/or after they are taken from a storage or store room. In this way it is possible to utilize, for instance, certain proportions of an oven's exhaust heat, which would otherwise be conducted outside, for producing the energy for the basic heating. The oven's exhaust heat can be taken advantage of by, for instance, deflecting the warm exhaust air and/or conducting this exhaust air through suitable heat exchangers for cooling it, thus representing a potential for energy saving.

The hot air utilized in the first temperature control stage for preheating the preforms may however also, at least partly, be generated from the waste process heat of other components of a container production, container handling, and/or container filling machine or facility. In particular, the hot air utilized in the first temperature control stage for preheating the preforms may be generated from the waste process heat of the heating line for the heating process of the preforms prior to blow molding or stretch blow molding. Alternatively or in combination with this procedure, it is possible to generate the hot air utilized in the first temperature control stage for preheating the preforms from the waste process heat of other facilities within the container handling and/or filling line, such as the facilities for pasteurizing, sterilizing, hot filling, or the like.

In particular, exhaust air should be used from machines that are located close to the so-called preform infeed, i.e. the system for feeding in the preforms. In the simplest case the heat is transferred via a simple pipe to the preform infeed located above, and then transferred by convection. Ventilators may also be employed for conducting the hot air. Preferably, the pipes are insulated. The preforms are preferably preheated after being sorted, so that it is possible to adjust the settings for the heating process more uniformly. An advantageous embodiment can provide a small tunnel from the feeding track to the blow molding machine.

A further advantageous variant of the method according to the invention can provide temperature regulation subsequent to the preheating process or temperature detection after the preheating process and a subsequent adjustment of the heating parameters, in particular individually for each preform. The temperature range intended for preheating is between approximately 30°-90° C., preferably between 40°-70° C., and with special preference between 40°-60° C. It is preferable that only the bodies of the preforms are heated in the process, however not the support ring and the thread.

As already mentioned, the second heating stage essentially serves to apply a temperature profile to the preforms in this temperature profiling phase, with said temperature profile being adjusted and/or varying along the length of said preforms. In order for the preform's thread section to maintain dimensional stability during the subsequent process steps, special attention should be paid not to apply too much heat to the thread section when heating the neck section and the remaining preform. As the thread section and the so-called neck ring (support ring) are required for handling and transport purposes, it is important not to modify and deform these sections of the preform. In the section of the second heating stage, the preforms can be heated in particular by radiant heating devices. In order to avoid overheating, said radiant heating devices may be provided with a regulated surface cooling system.

It is alternatively possible for the temperature profiling phase to be carried out not prior to, but rather immediately together with the blow molding process. This is for instance possible when employing microwave or laser heating for profiling the temperature distribution.

In order to achieve the above mentioned object of the invention, a heating device is additionally provided for controlling the temperature of preforms made from a thermoplastic material for a subsequent blow molding or stretch blow molding process. This heating device according to the invention is provided with at least two stages and comprises a preheating stage for applying hot air to the preforms in order to achieve a largely homogeneous base temperature. The system for applying hot air is coupled to further components of a container producing, container handling, and/or container filling machine in order to utilize the exhaust heat supplied by these machine parts. In addition, it is optionally possible to provide a heating element that is inserted into the preforms in the first heating stage, so that the preforms are heated and brought to the base temperature from inside. Furthermore, it is possible to provide a temperature sensor, which is disposed downstream of the first and upstream of the second heating stage and which is coupled via signal transmission to a control unit for regulating the heat output of the first heating stage and/or the temperature profiling stage.

An especially advantageous variant of the heating device provides for the preheating stage to be coupled to a heating line, which is disposed upstream of a facility for blow molding or stretch blow molding the preforms, so that the waste process heat of said heating line can be utilized. This allows to save energy by utilizing the waste process heat that would otherwise not be used. By accordingly regulating the utilization and supplying of exhaust heat, it is in addition possible to define and maintain the conditions and parameters of the preheating process very precisely.

It is optionally possible to couple the preheating stage with at least one facility within the container handling and/or filling line for pasteurizing, sterilizing, and/or hot filling in order to utilize the waste process heat of the said facility. It is furthermore possible to use the exhaust heat of electrical machines, for instance of electrical drive motors required for driving various components in complex machines.

Other aspects, embodiment variants, and advantages in the configuration and operation of the heating device according to the invention are to be seen in the context of the method variants already mentioned above, as all the method variants are to be regarded as options for operating the heating device.

Furthermore, it must be pointed out here that the present invention is generally suited for use in microwave ovens, rotary ovens, linear ovens, stationary ovens, etc. It is furthermore possible to use individual heating jackets, whereby each preform is selectively temperature-controlled in a separate heating jacket. For purposes of completeness, it should be noted that in addition to the two mentioned, separate heating stages, it is possible to provide further heating stages, as the case may be, without requiring a detailed explanation here.

A further appropriate option of the heating device according to the invention or of the temperature control method according to the invention may consist in spacing the preforms at distinctly smaller intervals during preheating than during the later blow molding process in order to improve energy input and achieve a more effective utilization of the input heating energy. The spacing during heating can thus, for instance, be only about half or even less of the spacing during the blow molding process, in order to heat the preforms especially effectively when they are much closer together. Spacing during the blow molding process, on the other hand, is determined by the machine's technical parameters and usually cannot be further reduced. The spacing selected for preheating can, in particular, be smaller than approximately 80 mm, preferably even smaller than approximately 40 mm.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows a schematic illustration of a container forming device for shaping containers for liquids from preforms by stretch blow forming.

FIG. 2 shows a heating line according to FIG. 1 in a schematic illustration.

FIG. 3 shows a schematic view of a preferred embodiment variant of the container forming device according to FIG. 1.

FIG. 4 shows a further variant of a container forming device with an additional preheating process.

FIG. 5 shows a detailed view of the booster or the first heating stage.

FIG. 6 shows a schematic illustration of a blow molding device that utilizes exhaust heat for preheating the preforms.

FIG. 7 shows the components of a stretch blow molding device with the various possibilities of utilizing exhaust heat.

### DETAILED DESCRIPTION

The same or equivalent elements of the invention are designated by identical reference characters. Furthermore and for the sake of clarity, only the reference characters relevant for describing the respective figure are provided. It should be understood that the detailed description and specific examples of the device and method according to the invention, while indicating preferred embodiments, are intended for purposes of illustration only and are not intended to limit the scope of the invention.

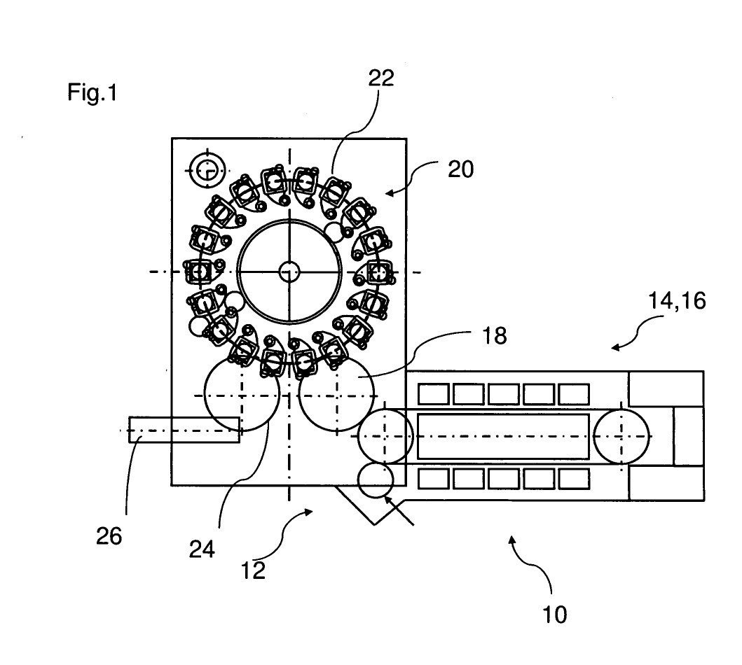

The schematic illustration of FIG. 1 shows a container forming device 10 for shaping containers for liquids from preforms by means of stretch blow forming. The container forming device 10 comprises a rotating entry area 12 for the preforms, a heating line 14 with a regulated two-stage heating device 16 for the temperature control of the preforms and a subsequent adjacent first transfer star 18 for conveying the temperature-controlled preforms to a rotating stretch blow molding device 20. The rotating stretch blow molding device 20 comprises a plurality of blow molding stations 22, where the preforms are formed to make containers for liquids, before they are transferred by means of a second transfer star 24 to a linear conveying device 26, which is used for conveying the containers, in particular to a filling station (not illustrated here).

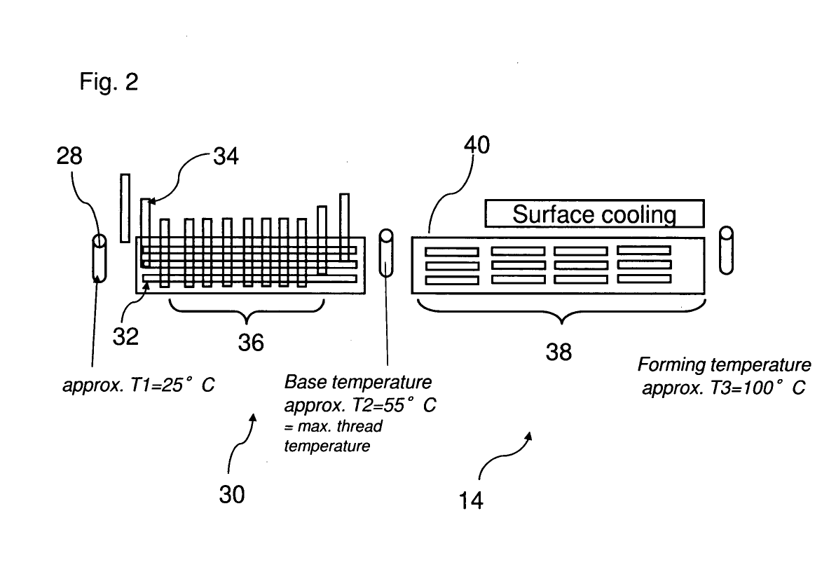

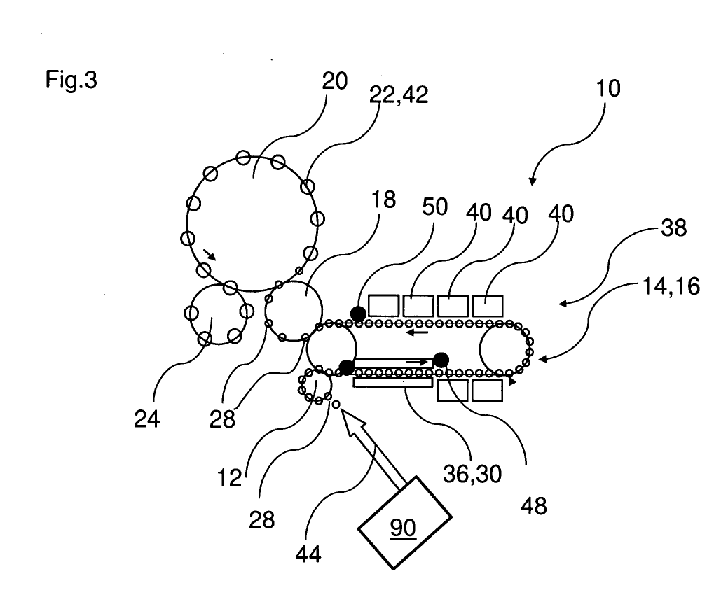

The schematic illustration of FIG. 2 gives a schematic representation of a heating line 14 according to FIG. 1, whereby said heating line 14 is part of the heating device. In the heating line 14, the initially relatively cold preforms 28 that may have, for instance, a temperature T1 of approximately 25° C., are preheated in the first heating stage 30 (cf. FIG. 3) to a base temperature T2 of approximately 55° C. In the present exemplary embodiment, this base temperature T2 corresponds to the maximum thread temperature that the preforms 28 may be exposed to without deforming the thread section. The first heating section 30 can optionally comprise a radiator section 32 with infrared radiators and/or additional heating elements 34, which can be individually inserted into the preforms 28 for quick and precise heating. Both heating devices 32 and 34 can optionally be combined with each other, with the result that the first heating stage 30 will act as a booster 36 for bringing the preforms 28 quickly and precisely to the desired base temperature T2 (here: approximately 55° C.).

The subsequent adjacent second heating stage 38 also comprises a radiator section 40 with infrared radiators, which are, however, variably regulated in order to create the desired temperature profiling, with the result that, on the one hand, the necessary forming temperature T3 of approximately 100° C. is achieved, but, on the other hand, the thread section of the preforms 28 is kept at the temperature level of T2.

The illustration in FIG. 3 shows a schematic view of a preferred embodiment variant for the container forming device according to FIG. 1. Again, the container forming device 10 with the rotating entry area 12 for the preforms 28, the heating line 14 with the regulated two-stage heating device 16 for the temperature control of the preforms 28 and the subsequent adjacent rotary first transfer star 18 for conveying the temperature-controlled preforms 28 to the rotating stretch blow device 20 are illustrated here. The preforms 28 are taken out of a supply 90 and transferred to the rotating entry area 12 by a linear feed path 44. In this rotating stretch blow device 20, the preforms 28 are formed to make containers for liquids 42 by means of blow molding stations 22 located at the outer circumference of said preforms 28, before they are transferred to the conveying device 26 (cf. FIG. 1) by means of the second transfer star 24, which conveys the containers 42 to the filling station or any other handling station (not illustrated here).

Just behind the entry area 12 the heating line 14 comprises the booster 36 or the first heating stage 30 for the basic heating of the preforms 28. Downstream of the booster 36 are the radiator areas 40 of the second heating stage 38, which is indicated in the presented exemplary embodiment by altogether six consecutively arranged heating boxes. Upstream of the rotating entry area 12 with the entry star wheel is a linear feed path 44 for feeding the preforms 28 to the container forming device 10.

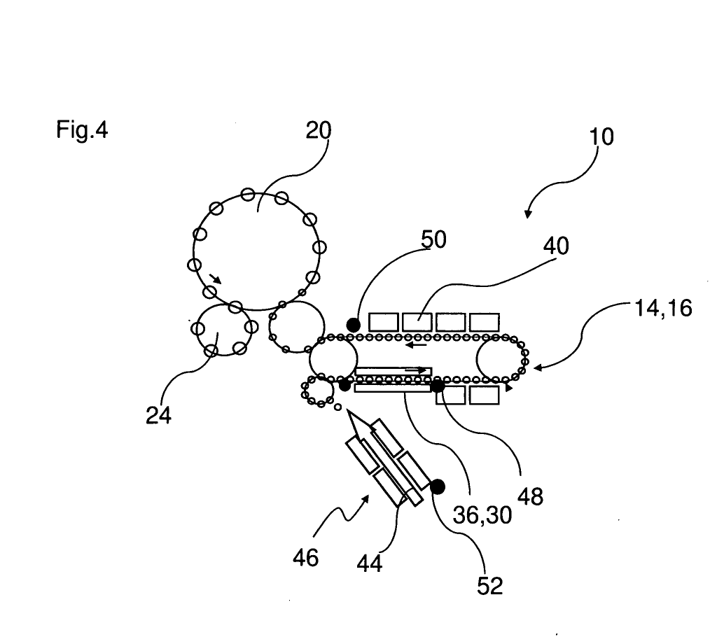

According to FIG. 4, it is possible to equip this linear feed path 44 with an additional preheating device 46, which may be supplied, for instance, with exhaust heat from the heating device 16 or the like, thus allowing the utilization of a considerable amount of thermal energy that would otherwise be discharged without being used for preheating the preforms 28, and in this way to contribute to the efficiency increase of the temperature control process. The rest of the construction of device 10 is the same as the embodiment variant according to FIG. 3.

It is alternatively possible for the preheating device 46, which is supplied with the exhaust heat from the heating device or the like, to function as the first heating stage 30 and thus to guarantee that the preforms 28 are uniformly preheated, before they enter the second heating stage 38 for temperature profiling. This arrangement will at any rate contribute to increasing the efficiency of the temperature control process.

Both variants according to FIG. 3 and FIG. 4 have the temperature measurement points in common, which are schematically indicated. The first temperature sensor 48 is thus located immediately downstream of the first heating stage 30 or the booster 36. The second temperature sensor 50 is located downstream of the second heating stage 38, i.e. downstream of the last heating box with the radiator sections 40 arranged therein, as is illustrated in the FIGS. 3 and 4, respectively. According to FIG. 4, there can optionally be a third temperature sensor 52 in the linear feed path 44 and the preheating 46 or located upstream of these sections. The output signal of the said third temperature sensor 52 can preferably be taken into account in an additional control loop of the heating device 14.

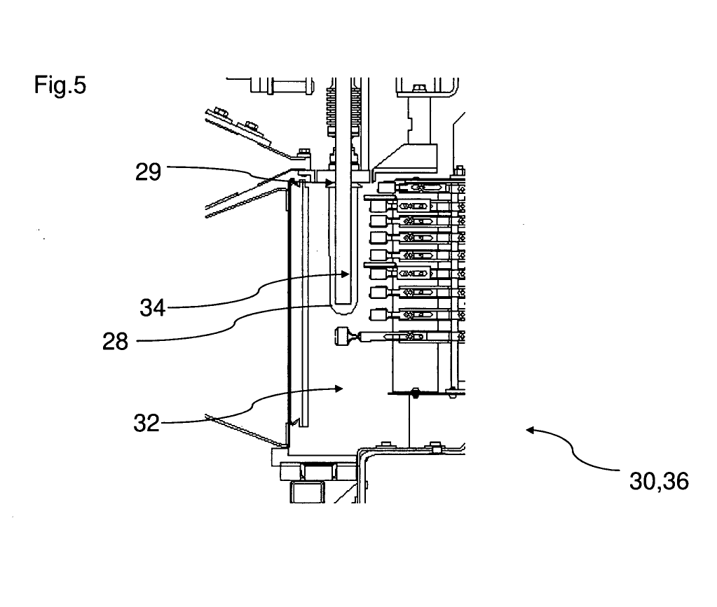

The detailed view in FIG. 5 illustrates an embodiment variant of the first heating stage 30 or the booster 36. According to FIG. 2, it is possible to allow for the preform 28 with an upper thread section 29 to be heated to the base temperature T2 of approximately 55° C. by means of the heating element 34 being completely inserted into the said preform and/or by means of the infrared radiators in the radiator section 32. The radiators of radiator section 32 can preferably be provided with a suitable cooling system in order to avoid overheating of the radiators in the heating oven by circulating cooling air.

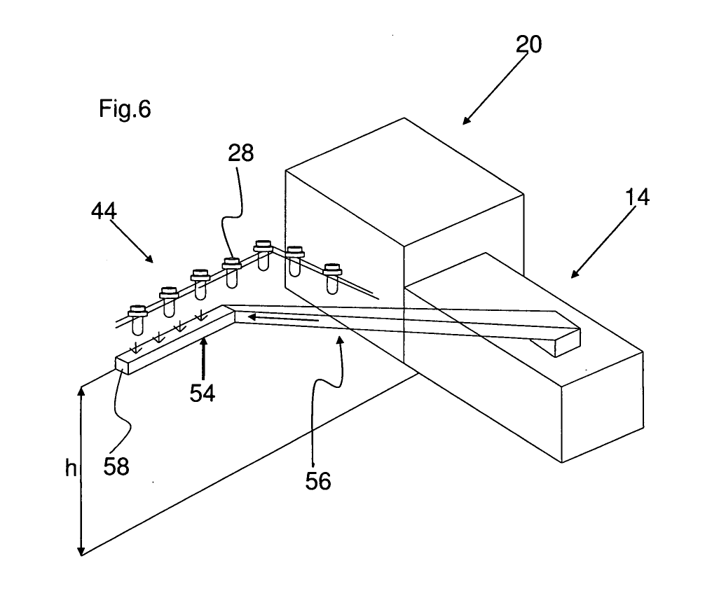

The schematic illustration of FIG. 6 renders a principal variant of utilizing the exhaust heat 54 from the heating line 14 and/or from a heating device connected to the stretch blow molding device 20 or required there for the blow molding process, whereby the said exhaust heat can be supplied to the preforms 28 via an exhaust air duct 56 of a heating nozzle 58 in the feed path 44. In the already known configurations the exhaust heat from the heating line 14 and/or from the blowing module is discharged, without further energetic utilization, into the surrounding area or the surrounding hall; this variant for utilizing the exhaust heat according to FIG. 6 therefore represents a clear increase in efficiency. For the sake of clarity, the other components of heating line 14 are not illustrated in FIG. 6. In particular, it is possible for a tunnel to be disposed around the heating nozzles and the preforms' transport path in order to avoid heat loss.

In particular, the exhaust air is transported without using additional ventilators, only through the heat rising to the preforms located higher above in the feeding area. It is also possible, however, to use ventilators or the recycled air from the stretch blow molding process for this purpose.

The conducts are specially insulated.

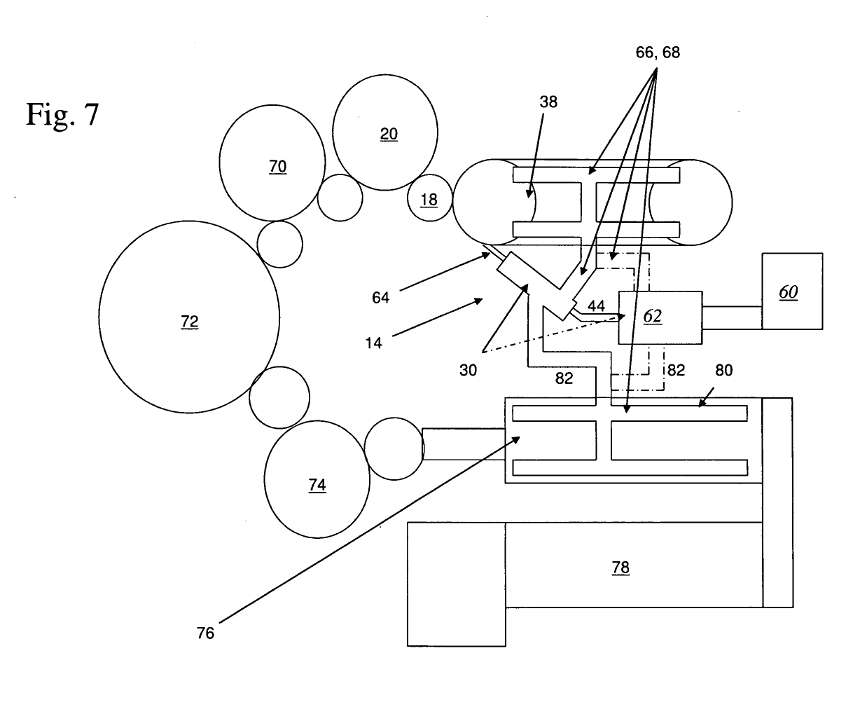

By rendering the various components of a stretch blow molding device 20 for producing containers for liquids from preforms, the schematic illustration of FIG. 7 represents various possibilities of utilizing the exhaust heat from different processes for preheating the preforms before they are transported into the heating line. The preforms are kept in a storage device and from there they are supplied to, for instance, a chute 60, from where they enter a roller or disc sorter 62 for the purpose of being sorted. From this sorter 62 they enter, via the feed path 44, the first heating stage 30 or the booster 36 of the heating line 14, where the preforms are preheated to a base temperature T2 (cf. FIG. 2), with said temperature being largely homogeneously distributed across the entire volume of each of the preforms. After this basic heating, the preforms are conveyed via a second feeding track 64 into the second heating stage 38 of the heating line 14, where they are heated according to the desired temperature profile to an inhomogeneous blowing temperature T3 (according to FIG. 2).

As illustrated by FIG. 7, the oven of the second heating stage 38 has several exhaust air ducts 66, which can lead, via connection channels 68, to the first heating stage 30 and/or to the sorter 62 to be used for preheating the preforms there. This connection channel 68 between the oven and the sorter 62 is to be considered as optional and indicated by a dotted line.

Via the first transfer star 18, the preforms that have been heated in preparation for the stretch blow molding process are conveyed to the so-called blowing wheel of the stretch blow molding device 20, where they are shaped to containers for liquids, and subsequently they are conveyed into an integrated container forming and filling machine and there consecutively to a rinser 70, a filling device 72, a labeling device 74, a pasteurizing device 76 as well as a subsequent adjacent packaging module 78, where they can be assembled to form packages and/or palettes or other packaging units and made ready for dispatch as required. As indicated in FIG. 7, the heat-intensive pasteurizing device 76 provides another possibility for effectively utilizing exhaust heat, indicated by the appropriate exhaust heat ducts 80 and connection channels 82, which lead to the preheating stage 30 and/or to the sorter 62.

The processing stations of the integrated machine illustrated in FIG. 7 are to be regarded as useful options, some of which could also be omitted. The general aim, however, was to show the most effective variants for utilizing the exhaust heat as well as different possible variants and combinations of these variants.

In particular for the purpose of the uniformity of the preheating applied to the preforms, it is also possible to include a control system for regulating the preheating temperature by means of temperature sensors. According to the number of infrared radiators turned on in the oven, the exhaust air is either warmer or cooler; therefore an additional air heater can be included upstream of the preheating unit in order to ensure a constant air temperature. A sensor for recording the preforms' temperature at the end of the preheating unit can be included as well as another one upstream of the additional air heater for measuring the temperature of the oven exhaust in the exhaust air ducts.

The invention has been described with reference to preferred embodiments or embodiments that are to be regarded as optional, as illustrated in the FIGS. 1 to 7. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

List of Reference Characters:
10 Container forming device
12 Entry area
14 Heating line
16 Heating device
18 First transfer star
20 Stretch blow molding device
22 Blow molding station
24 Second transfer star
26 Conveying device
28 Preform
29 Thread section
30 First heating stage
32 Radiator area
34 Heating element
36 Booster
38 Second heating stage
40 Radiator area
42 Container for liquids
44 Linear feed path
46 Preheating device
48 First temperature sensor
50 Second temperature sensor
52 Third temperature sensor
54 Exhaust heat
56 Exhaust air duct
58 Heating nozzle
60 Chute
62 Sorter, roller or disc sorters
64 Feeding track
66 Exhaust air duct
68 Connection channel
70 Rinser
72 Filling facility
74 Labeling facility
76 Pasteurizing facility
78 Packaging module
80 Exhaust heat duct
82 Connection channel
90 supply
T1 Initial temperature
T2 Base temperature/maximum thread temperature
T3 Forming temperature

What is claimed is:

1. A method for an at least two-stage temperature control of preforms made from a thermoplastic material, the method comprising:
preheating the preforms to a near uniform temperature having a largely homogeneous temperature distribution using hot air at least partly generated from waste process heat of other components of at least one of a container production machine, a container handling machine and a container filling machine; and
heating the preforms, prior to or during a blow molding or stretch blow molding process, to a process-specifically distributed softening temperature according to a predefineable thermal profile, the softening temperature being the temperature required for blow molding or stretch blow molding at least a body section of each preform located below at least one of a thread section and a collar area located therebelow.

2. The method according to claim I wherein heating the preforms includes at least two distinct, consecutive heating stages including a first heating stage where the preforms are heated such that each entire preform is heated to a uniform base temperature, and the base temperature is less than or equal to a maximum heating temperature for maintaining the dimensional stability of the thread section at an open-topped neck section of each preform.

3. The method according to claim 2 wherein the preforms are heated to the base temperature in the section of the first heating stage by inserting heating elements into the open-topped neck sections of the preforms.

4. The method according to claim 2 wherein the preheating includes applying hot air to the preforms either before the preforms are conveyed into a heating device or at least one of while the preforms are inside a heating device and after the preforms are taken from a storage location.

5. The method according to claim 4 wherein the preheating is performed prior to or during the first heating stage and the hot air used for the preheating is generated from waste process heat of the heating line, before the preforms are shaped by blow molding or stretch blow molding.

6. The method according to claim 4 wherein the hot air used for preheating the preforms in the first heating stage is generated from waste process heat of at least one of a pasteurizing facility, a sterilizing facility and a hot filling facility within at least one of a container handling line and a filling line.

7. The method according to claim 1 wherein the temperature of the preforms is measured after the preheating and used for at least one of adjusting and controlling heating parameters of at least one of the preheating process and of a temperature profiling stage.

8. A heating device for the temperature control of preforms made from a thermoplastic material for a subsequent blow molding or stretch blow molding process comprising:
at least two heating sections including a preheating section having a hot air application for bringing the preforms to a largely homogeneous base temperature, the preheating section being coupled to exhaust gas of at least one component of at least one of a container production machine, a container handling machine and a container filling machine and using the exhaust gas for preheating the preforms.

9. The heating device according to claim 8 further comprising:
a heating line coupling the the preheating section to waste process heat of the at least one component of the at least one of the container production machine, the container handling machine and the container filling machine; and
a blow molding or stretch blow molding station, the heating line being disposed upstream of the blow molding or stretch blow molding station.

10. The heating device according to claim 8 wherein the preheating section is coupled to at least one of a pasteurizing facility, a sterilizing facility and a hot filling facility within at least one of the container handling machine and the container filling machine in order to use the waste process heat thereof.

11. The heating device according to claim 8 wherein the preheating section comprises at least one heating element inserted into the preforms, the heating element heating the preforms from the inside and bringing the preforms to a base temperature.
